(19) United States
(12) Patent Application Publication
(10) Pub. No.: US 2025/0178128 A1
(43) Pub. Date: Jun. 5, 2025

(54) Method and System for Producing a Structural Component

(71) Applicant: Bayerische Motoren Werke Aktiengesellschaft, Muenchen (DE)

(72) Inventors: Alexander GRIMM, Karlsfeld (DE); Felix HAECKEL, Muenchen (DE)

(21) Appl. No.: 18/845,012

(22) PCT Filed: Feb. 6, 2023
(86) PCT No.: PCT/EP2023/052831

§ 371 Date: Sep. 9, 2024

(30) Foreign Application Priority Data
Mar. 10, 2022 (DE) 10 2022 105 591.4

(51) Int. Cl. B23K 26/342; B33Y 10/00; B33Y 30/00; B33Y 40/00

(52) U.S. Cl. CPC B23K 26/342; B33Y 10/00; B33Y 30/00; B33Y 40/00

(57) ABSTRACT

A method for producing a structural component includes building a first base body layer by layer, positioning a supplementary profile on the first base body, and building a second base body layer by layer. The method further includes fastening the supplementary profile to the first base body and to the second base body by substance-to-substance bonding while enclosing the supplementary profile at least partially between the first base body and the second base body.

### BACKGROUND AND SUMMARY

The present invention relates to a method, to a system and to a computer program product for producing a structural component. The invention relates further to a computer-readable storage medium on which a computer program product is stored.

Various additive manufacturing methods for building structural components layer by layer are known in the prior art. These include, for example, laser sintering, laser beam melting, 3D printing, or thermal transfer sintering. By means of these methods, structural components can in each case be built up generatively. A challenge in the case of structural components of the type in question is to stably connect them to further components or to fasten attachment parts to the additively manufactured structural components. Reasons for this are, inter alia, the mechanical and, for example, the anisotropic mechanical properties of the additively manufactured structural components.

The object of the present invention is to take account of the above-described problem at least partially. In particular, the object of the present invention is to produce by means of an additive manufacturing method an improved structural component having local fastening regions.

The above object is achieved by the patent claims. Further advantages of the invention will become apparent from the dependent claims, the description, and the figures. Features which are described in connection with the method naturally also apply in connection with the system according to the invention, with the computer program product according to the invention, and with the storage medium according to the invention, and in each case vice versa, so that reciprocal reference is and/or can always be made in respect of the disclosure relating to the individual aspects of the invention.

According to a first aspect of the present invention, a method for producing a structural component is provided. The method comprises the following steps:
building a first base body layer by layer,
positioning a supplementary profile on the first base body,
fastening the supplementary profile to the first base body by substance-to-substance bonding, and
building a second base body layer by layer so as to continue the formation by substance-to-substance bonding of the first base body with the supplementary profile fastened thereto while enclosing the supplementary profile at least partially between the first base body and the second base body by substance-to-substance bonding.

It has been recognized within the scope of the present invention that a structural component having improved local fastening possibilities and/or other functional properties can be created by interrupting the initial layer building to produce the structural component and introducing a prefabricated supplementary profile. That is to say, no attempt is made to produce a fastening and/or attachment point in the layering process, but instead this is dispensed with in favor of a correspondingly prefabricated supplementary profile. The supplementary profile is then incorporated into the finished structural component at least partially by substance-to-substance bonding. The supplementary component is preferably a component that is of the same type as the first base body and/or the second base body, or a component that is made of a material of the same type. If the first base body and the second base body are made of plastics material, for example, a supplementary profile of plastics material is preferably also used. If the first base body and the second base body are made of metal, a supplementary profile of metal is preferably used. It is, however, also possible in principle to use different materials, that is to say, for example, a supplementary profile of plastics material if the base bodies are manufactured from metal, and vice versa.

Hitherto, it has been assumed that any form of a functional portion in the structural component can or should be produced within the scope of the additive manufacturing process, at least when the type of material remains or is to remain homogeneous. Interruption of the layer building has been avoided as far as possible. The present invention now turns away from this with the integration of the supplementary profile.

The supplementary profile can be understood as being a sheet-metal component or a more solid molded component having the desired function in the structural component that is subsequently finished. The supplementary profile preferably has a homogeneous material structure. That is to say, a homogeneous supplementary profile is preferably used. The supplementary profile can in principle have any possible geometric form.

In a method according to the invention, it is possible that at least one supplementary profile is fastened to the first and/or to a further base body. That is to say, at least one supplementary profile can be fastened in the manner described above to the first base body. It is further possible that a plurality of supplementary profiles are fastened to different base bodies. That is to say, for example, a first supplementary profile can be incorporated between the first and second base bodies by substance-to-substance bonding, a second supplementary profile can be incorporated between the second and a third base body by substance-to-substance bonding, a third supplementary profile can be incorporated between the third and a fourth base body by substance-to-substance bonding, etc. The supplementary profiles can here be incorporated one above the other and/or one beneath the other.

As has already been mentioned in the introduction to the description, the building of the base bodies layer by layer can be understood as meaning building by means of additive manufacture. The method can thus be performed within the scope of 3D printing, generative manufacture and/or rapid technology. The structural component is preferably produced in the form of an automotive component. Positioning of the supplementary profile on the first base body can be understood as meaning placing the supplementary profile against and/or on the first base body. That is to say, the supplementary profile is preferably brought into direct contact with the base body. Enclosing the supplementary profile between the first base body and the second base body by substance-to-substance bonding can be understood as meaning that the supplementary profile is fastened, in particular directly fastened, to the first base body and also to the second base body by means of substance-to-substance bonding, and the two base bodies are also connected to one another by substance-to-substance bonding.

According to a further embodiment of the present invention, it is possible that, in a method, the building of the first base body and of the second base body layer by layer is carried out by means of powder-based welding. Powder-based welding allows the structural component to be manufactured with high precision. In powder-based welding, metal powder can be melted to produce the first base body and the second base body. The method is in this case carried out in particular to produce a structural component of metal, preferably wholly of metal.

It is further possible that, in a method according to the invention, the building of the first base body and of the second base body layer by layer is carried out by means of wire-based welding. With wire-based welding, particularly short manufacturing times for the structural component can be achieved. In wire-based welding, in order to produce the first base body and the second base body, a filler material in the form of wire can be melted and built up layer by layer to form the first and/or second base body. Wire-based welding can be carried out using a laser, an electron beam or an electric arc.

It can be particularly advantageous if, in a method according to the present invention, the wire-based welding is carried out by means of WAAM (wire arc additive manufacturing). Tests within the scope of the present invention have shown that it can be advantageous, even in the case of this method, to interrupt the additive manufacturing method in order to integrate a prepared supplementary profile between two base bodies.

In a method according to the invention, the supplementary profile can be fastened to the first base body as a fastening profile for fastening attachment parts to the structural component and/or for fastening the structural component to a further structural component. Thus, the supplementary profile can have a structure with which it can be used in the finished structural component, for example, as a flange and/or flange point for the connection of further components. Thus, the structural component can be used, for example, as a metal component for use in a vehicle, for example as a load-bearing component in a vehicle, in particular in a motor vehicle. The method can thus be carried out, for example, in order to produce a bodywork component for a vehicle.

According to a further embodiment variant of the present invention, it is possible that, in a method, the supplementary profile is positioned on the first base body by means of an automated positioning unit. The positioning unit can be understood as being, for example, a robot or a robotic arm. As a result, the method can be carried out particularly quickly and reliably.

As has already been mentioned above, it can further be advantageous if, in a method according to the present invention, the supplementary profile has a different material composition and/or a different material structure to the first base body and the second base body. In particular, the material structures can differ from one another, while the type of material is the same. The desired functions and/or material properties can thus be produced locally in the structural component in a simple and reliable manner.

According to a further aspect of the present invention, a system for producing a structural component is provided. The system has an automated positioning unit and an automated building unit, wherein the building unit is configured and designed to build a first base body layer by layer, the positioning unit is configured and designed to position a supplementary profile on the first base body, the building unit is configured and designed to fasten the supplementary profile to the first base body by substance-to-substance bonding, and the building unit is configured and designed to build a second base body layer by layer so as to continue the formation by substance-to-substance bonding of the first base body with the supplementary profile fastened thereto while enclosing the supplementary profile at least partially between the first base body and the second base body by substance-to-substance bonding. The system according to the invention thus has the same advantages as have been described in detail with reference to the method according to the invention. In a system according to the present invention, it is possible that the building unit for building the first base body and the second base body has a welding unit for powder-based welding or for wire-based welding. The system can further be configured and designed to carry out a method as described above.

A further aspect of the present invention relates to a computer program product comprising commands which, when the computer program product is executed by a computer, cause the computer to carry out the described method with a system as described above. There is additionally provided a computer-readable and preferably non-volatile storage medium on which such a computer program product is stored. The computer program product according to the invention and the storage medium according to the invention thus likewise have the advantages described above.

The computer program product can be implemented as computer-readable instruction code in any suitable programming language and/or machine language such as, for example, in JAVA, C++, C# and/or Python. The computer program product can be stored on a computer-readable storage medium such as a data disk, a removable disk drive, a volatile or non-volatile memory, or an embedded memory/processor. The instruction code can program a computer or other programmable devices such as a controller in such a manner that the desired functions are performed. Furthermore, the computer program product can be and/or can have been made available in a network such as, for example, the internet, from which it can be downloaded by a user as required. The computer program product can be and/or can have been implemented both by means of software and by means of one or more special electronic circuits, that is to say in hardware form or in a hybrid form of any kind, that is to say by means of software components and hardware components.

Further measures enhancing the invention will become apparent from the following description of various exemplary embodiments of the invention, which are shown schematically in the figures. All the features and/or advantages which follow from the claims, the description or the figures, including structural details and spatial arrangements, can be essential for the invention both on their own and in the various combinations.

### BRIEF DESCRIPTION OF THE DRAWINGS

FIG. 1 shows a system according to the invention in a first operating state;

FIG. 2 shows a system according to the invention in a second operating state;

FIG. 3 shows a system according to the invention in a third operating state; and

FIG. 4 shows a storage medium with a computer program product in accordance with an embodiment according to the invention stored thereon.

### DETAILED DESCRIPTION OF THE DRAWINGS

Elements having the same function and effect are in each case provided with the same reference signs in the figures.

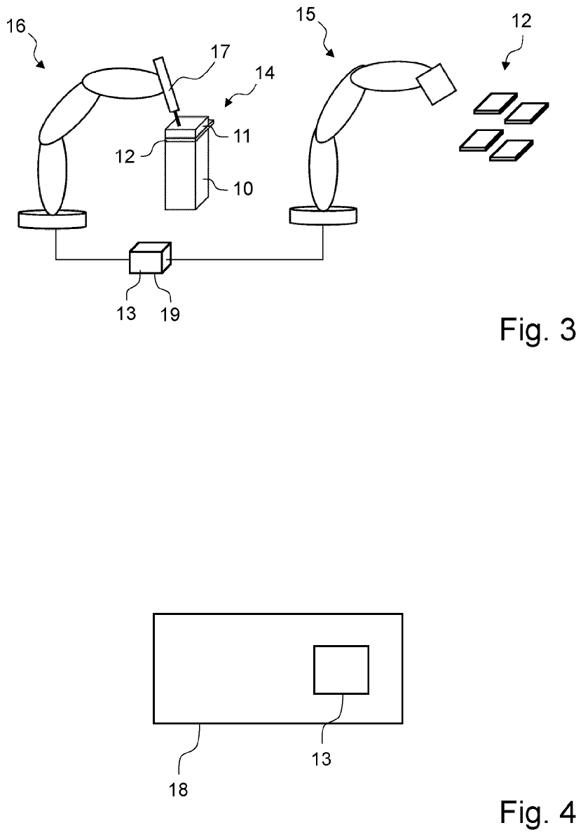

FIG. 1 shows a system 20 for producing a structural component 14 shown in FIG. 3. For this purpose, the system 20 has an automated positioning unit 15 in the form of an industrial robot, and an automated building unit 16, likewise in the form of an industrial robot. The building unit 16 has a welding unit 17. The positioning unit 15 and the building unit 16 are connected to a controller 19 which is configured to control the positioning unit 15 and the building unit 16. For executing the control commands necessary for this purpose, a corresponding computer program product 13 is installed in the controller 19.

Referring to FIGS. 1 to 3, a WAAM method for producing a structural component 14 in the form of a bodywork component for a motor vehicle will now be described. To this end, in a first step, which is shown in FIG. 1, a first base body 10 is built layer by layer by means of the welding unit 17 of the building unit 16.

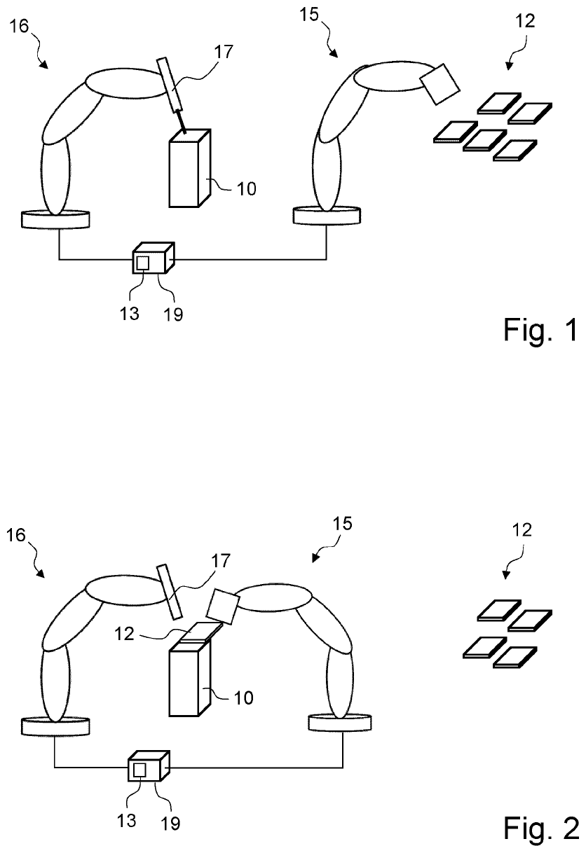

In a second step, which is shown in FIG. 2, the positioning unit 15 grasps a prepared supplementary profile 12 and positions it on the first base body 10. The supplementary profile 12 is a metal component and thus has the same material type as the first base body 10 and the second base body 11.

In a subsequent third step, which is shown in FIG. 3, a second base body 11 is built layer by layer by means of the building unit 16, or by means of the welding unit 17. The supplementary profile 12 is here fastened to the first base body 10 and to the second base body 11 by substance-to-substance bonding, or is enclosed between the first base body 10 and the second base body 11 by substance-to-substance bonding.

In the example shown, the supplementary profile 12 has a different material structure to the first base body 10 and the second base body 11. More specifically, the supplementary profile has a homogeneous material structure or at least a more homogeneous material structure than the first base body 10 and the second base body 11. The supplementary profile 12 can thus serve in the finished structural component 14 as a fastening profile, for example as a fastening flange, for fastening attachment parts to the structural component 14 and/or for fastening the structural component 14 to a further structural component 14.

FIG. 4 shows a computer-readable and non-volatile storage medium 18 with a computer program product 13 stored thereon. The computer program product 13 comprises commands which, when the computer program product 13 is executed by a computer, for example by the controller 19, cause the computer to carry out, with the system 20 shown, the described method for producing the structural component 14.

The invention permits further design principles in addition to the embodiments shown. That is to say, the invention is not to be considered as being limited to the exemplary embodiments explained with reference to the figures. Building of the first base body 10 and of the second base body 11 layer by layer can be carried out, for example, by means of powder-based welding or by means of wire-based welding. Furthermore, instead of a material type of the same kind, different material types can also be used to build the structural component 14. Thus, the first base body 10 and the second base body 11 could be produced layer by layer in the form of a plastics component, for example, and the supplementary profile 12 could nevertheless be provided in the form of a metal component or fastened between and to the first base body 10 and the second base body 11.

### LIST OF REFERENCE CHARACTERS

10 first base body
11 second base body
12 supplementary profile
13 computer program product
14 structural component
15 positioning unit
16 building unit
17 welding unit
18 storage medium
19 controller
20 system

1.-12. (canceled)

13. A method for producing a structural component, comprising the steps of:
building a first base body layer by layer;
positioning a supplementary profile on the first base body;
building a second base body layer by layer; and
fastening the supplementary profile to the first base body and to the second base body by substance-to-substance bonding while enclosing the supplementary profile at least partially between the first base body and the second base body.

14. The method according to claim 13, wherein the building of the first base body and of the second base body layer by layer is carried out by powder-based welding.

15. The method according to claim 13, wherein the building of the first base body and of the second base body layer by layer is carried out by wire-based welding.

16. The method according to claim 15, wherein the wire-based welding is carried out by wire arc additive manufacturing.

17. The method according to claim 13, wherein the supplementary profile is a fastening profile and wherein an attachment part is fastenable to the structural component via the fastening profile and/or wherein the structural component is fastenable to a further structural component via the fastening profile.

18. The method according to claim 13, wherein the supplementary profile is positioned on the first base body by an automated positioning unit.

19. The method according to claim 13, wherein the supplementary profile has a different material composition and/or a different material structure than the first base body and the second base body.

20. A system for producing a structural component, comprising:
an automated positioning unit; and
an automated building unit;
wherein the automated building unit is configured to build a first base body layer by layer;
wherein the automated positioning unit is configured to position a supplementary profile on the first base body;
wherein the automated building unit is configured to build a second base body layer by layer;
wherein the automated building unit is configured to fasten the supplementary profile to the first base body and to the second base body by substance-to-substance bonding while enclosing the supplementary profile at least partially between the first base body and the second base body.

21. The system according to claim 20, wherein the automated building unit has a welding unit for powder-based welding or for wire-based welding.

22. The system according to claim 20, wherein the system is configured to perform a method for producing the structural component, the method comprising the steps of:
building the first base body layer by layer;
positioning the supplementary profile on the first base body;
building the second base body layer by layer; and
fastening the supplementary profile to the first base body and to the second base body by substance-to-substance bonding while enclosing the supplementary profile at least partially between the first base body and the second base body.

23. A computer program product, comprising commands which, when the computer program product is executed by a computer, cause the computer to perform the method according to claim 13 with a system that comprises:
an automated positioning unit; and
an automated building unit;
wherein the automated building unit is configured to build a first base body layer by layer;
wherein the automated positioning unit is configured to position a supplementary profile on the first base body;
wherein the automated building unit is configured to build a second base body layer by layer;
wherein the automated building unit is configured to fasten the supplementary profile to the first base body and to the second base body by substance-to-substance bonding while enclosing the supplementary profile at least partially between the first base body and the second base body.
